(19) United States
(12) Patent Application Publication
(10) Pub. No.: US 2007/0121684 A1
(43) Pub. Date: May 31, 2007

(54) MULTIPLE WAVELENGTH LASER LIGHT SOURCE USING FLUORESCENT FIBER

(75) Inventors: Masaaki Yamazaki, Saitama-shi (JP); Osamu Ishii, Saitama-shi (JP); Naruhito Sawanobori, Saitama-shi (JP); Shinobu Nagahama, Saitama-shi (JP)

Correspondence Address: BARNES & THORNBURG LLP, P.O. BOX 2786, CHICAGO, IL, 60690-2786, US

(73) Assignee: SUMITA OPTICAL GLASS, INC., Saitama-shi (JP)

(21) Appl. No.: 11/456,164

(22) Filed: Jul. 7, 2006

(30) Foreign Application Priority Data
Nov. 30, 2005 (JP) 2005-346839

(51) Int. Cl. H01S 3/10

(52) U.S. Cl. 372/21

(57) ABSTRACT

A multiple wavelength laser light source using a fluorescent fiber includes a blue semiconductor laser element (2) for emitting an excitation light (a), and an optical fiber (17) having a first side fiber end face and a second side fiber face, the excitation light (a) from the blue semiconductor laser element (2) being made incident to the first side fiber end face, the excitation light (a) thus made incident to the first side fiber end face being emitted through the second side fiber face, in which the optical fiber (17) has dichroic mirror portions constituting a laser resonator (3) in its first and second side fiber end faces, respectively, and a core of the optical fiber (17) is made of a wavelength-converting member including a low phonon glass containing therein at least praseodymium ions as trivalent rare earth ions for emitting wavelength conversion lights by being excited by the excitation light (a).

The present application is based on Japanese patent application No. 2005-346839, the entire contents of which are incorporated herein by reference.

### BACKGROUND OF THE INVENTION

1. Field of the Invention

The present invention relates to a multiple wavelength laser light source using a fluorescent fiber, and more particularly to a multiple wavelength laser light source, using a fluorescent fiber, which is suitable for being used as various kinds of light sources such as a backlight light source for a liquid crystal television.

2. Description of Related Art

In recent years, a light-emitting device using a semiconductor light-emitting element such as a light-emitting diode (LED) element or a light amplification by stimulated emission of radiation (LASER) element has been widely utilized as various kinds of light sources because it is advantageous in miniaturization, an excellent power efficiency, and a long life as compared with the case of an incandescent lamp.

When such a light source, for example, is used as a backlight light source for a color laser display device in order to obtain an illuminating light (multiple wavelength laser light), three kinds of semiconductor light-emitting elements, i.e., red, green and blue semiconductor light-emitting elements are used.

Heretofore, a light source including three kinds of laser light sources, i.e., red, green and blue laser light sources as semiconductor light-emitting elements, and an optical fiber in which trivalent praseodymium ions (Pr³⁺) excited by an excitation light emitted from at least one laser light source among these three kinds of laser light sources are added to a core has been known as this sort of light source. This light source, for example, is disclosed in the Japanese Patent Kokai No. 2001-264662.

In addition, an argon ion laser device having a function of exciting trivalent praseodymium ions contained in zirconium fluoride system glass constituting a core of an optical fiber by an excitation light (its wavelength is 476.5 nm) emitted from an argon ion laser has also been known as another light source. This argon ion laser device, for example, is disclosed in Optics Communications89 (1991), pp. 333 to 340.

However, in the case of the light source disclosed in the Japanese Patent Kokai No. 2001-264662, the three laser light sources emit the three kinds of laser beams (red, green and blue laser beams), respectively. As a result, there is encountered such a problem that not only the number of components or parts increases to swell the cost, but also the overall light source is scaled up.

On the other hand, in the case of the argon ion laser device disclosed in Optics Communications89 (1991), pp. 333 to 340, the core of the optical fiber is made of the zirconium fluoride system glass. As a result, there is such inconvenience that not only the mechanical strength of the optical fiber is low and it is easy to be damaged, but also the chemical durability of the optical fiber is poor and when being used in the atmosphere, the optical fiber absorbs moisture, so that it is easy to be deteriorated. In addition, the excitation light having the wavelength of 476.5 nm which is emitted from the argon ion laser is used. As a result, there is also such inconvenience that the excitation light shows a blue-green color, and thus a desired (pure) blue light can not be obtained as a light emitted through a light emission face of the optical fiber.

### SUMMARY OF THE INVENTION

In the light of the foregoing, it is an object of the present invention to provide a multiple wavelength laser light source, using a fluorescent fiber, with which low cost promotion and miniaturization of the overall multiple wavelength laser light source can be realized, an optical fiber can be prevented from being damaged and deteriorated, and a desired blue light can be obtained as a light emitted from the optical fiber.

In order to attain the above-mentioned object, according to one aspect of the present invention, there is provided a multiple wavelength laser light source using a fluorescent fiber, including: a blue semiconductor laser element for emitting an excitation light; and an optical fiber having a first side fiber end face and a second side fiber end face, the excitation light emitted from the blue semiconductor laser element being made incident to the first side fiber end face, the excitation light thus made incident to the first side fiber end face being emitted through the second side fiber face, in which the optical fiber has dichroic mirror portions constituting a laser resonator in its first and second fiber side end faces, respectively, and a core of the optical fiber is made of a wavelength-converting member including a low phonon glass containing therein at least praseodymium ions as trivalent rare earth ions for emitting wavelength conversion lights by being excited by the excitation light.

In order to attain the above-mentioned object, according to another aspect of the present invention, there is provided a multiple wavelength laser light source using a fluorescent fiber, including: a blue semiconductor laser element for emitting an excitation light; and an optical fiber having a first side fiber end face and a second side fiber end face, the excitation light emitted from the blue semiconductor laser element being made incident to the first side fiber end face, the excitation light thus made incident to the first side fiber end face being emitted through the second side fiber end face, in which the optical fiber has dichroic mirror portions constituting a laser resonator in its first and second side fiber end faces, respectively, and a core of the optical fiber is made of a wavelength-converting member including a low phonon glass containing therein a phosphor for emitting wavelength conversion lights by being excited by an excitation light having a wavelength of 440 to 460 nm as the excitation light.

According to the present invention, the low cost promotion and miniaturization of the overall multiple wavelength laser light source can be realized, the optical fiber can be prevented from being damaged and deteriorated, and the desired blue light can be obtained as the light emitted through the optical fiber.

In order to attain the above-mentioned object, according to a further aspect of the present invention, there is provided a multiple wavelength laser light source using a fluorescent fiber, including: a blue semiconductor laser element for emitting a laser light; an optical fiber having a core for a wavelength-converting member containing a low phonon glass and at least praseodymium ions as trivalent rare earth ions, a first fiber end face to which the laser light is supplied, and a second fiber end face which is a light source for a multiple wavelength laser light; and first and second dichroic mirror portions, respectively, provided on the first and second fiber end faces of the optical fiber to provide a laser resonator for emitting the multiple wavelength laser light from the second fiber end face of the optical fiber.

### BRIEF DESCRIPTION OF THE DRAWINGS

FIG. 1 is a plan view for explaining a light-emitting device as a multiple wavelength laser light source using a fluorescent fiber according to a first embodiment of the present invention;

FIGS. 2A and 2B are respectively a perspective view and a cross sectional view for explaining a blue semiconductor laser element of the light-emitting device according to the first embodiment of the present invention;

FIG. 3 is a cross sectional view for explaining the fluorescent fiber of the light-emitting device according to the first embodiment of the present invention;

FIG. 4 is a spectrum diagram of an output light emitted from the light-emitting device according to the first embodiment of the present invention; and

FIG. 5 is a cross sectional view for explaining a fluorescent fiber of a light-emitting device according to a second embodiment of the present invention.

### DETAILED DESCRIPTION OF PREFERRED EMBODIMENTS

### First Embodiment

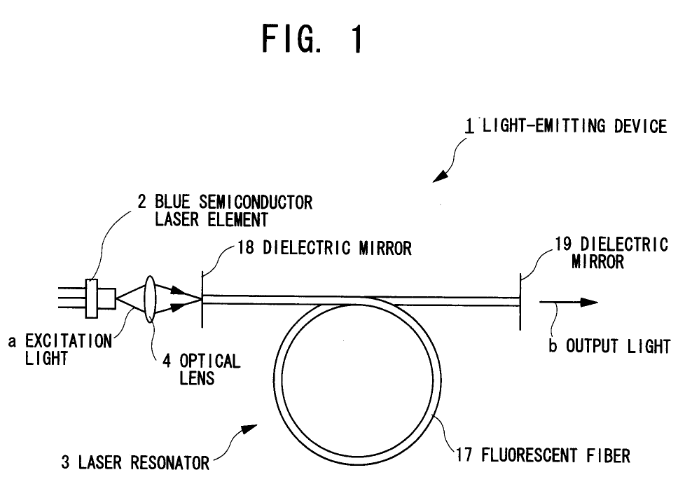

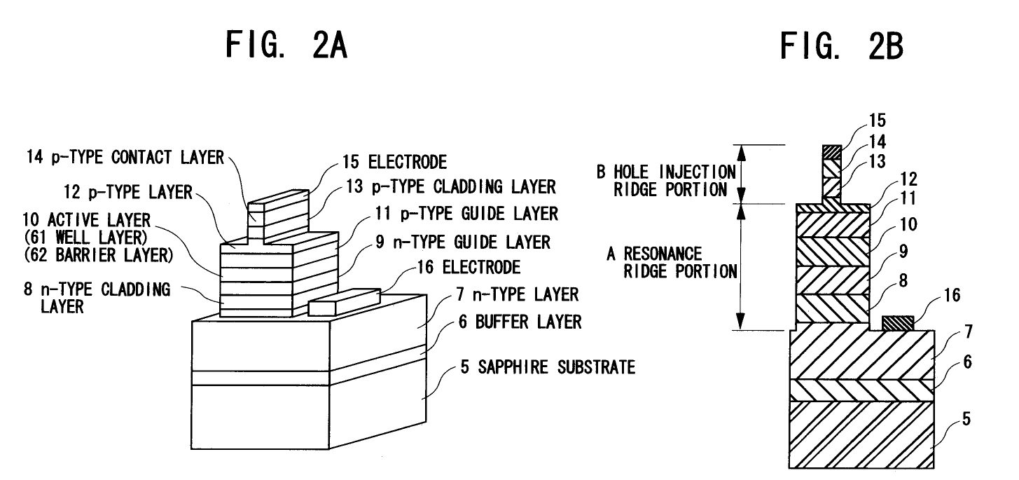

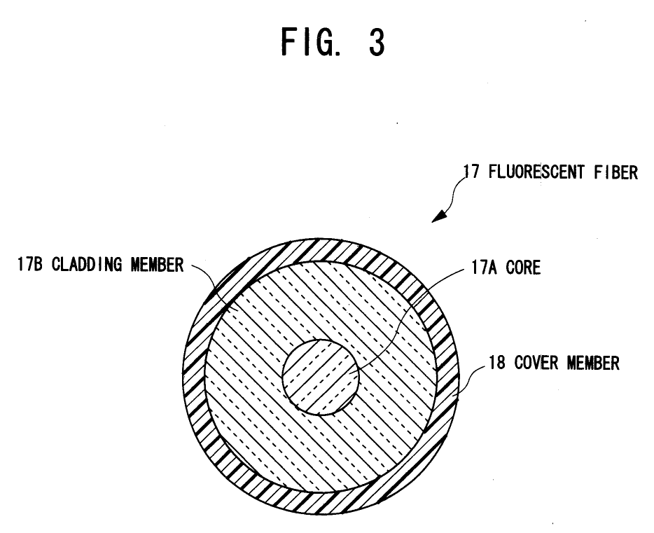

FIG. 1 is a plan view for explaining a light-emitting device as a multiple wavelength laser light source using a fluorescent fiber according to a first embodiment of the present invention. FIGS. 2A and 2B are respectively a perspective view and a cross sectional view for explaining a blue semiconductor laser element of the light-emitting device according to the first embodiment of the present invention. Also, FIG. 3 is a cross sectional view for explaining the fluorescent fiber of the light-emitting device according to the first embodiment of the present invention.

[Overall Construction of Light-Emitting Device 1]

Referring to FIG. 1, a light-emitting device 1 roughly includes a blue semiconductor laser element 2 as an excitation light source, a laser resonator 3 for amplifying an excitation light (blue light) “a” emitted from the blue semiconductor laser element 2, and wavelength conversion lights obtained through wavelength conversion by the excitation light “a” in accordance with induced emission, and an optical lens 4 interposed between the laser resonator 3 and the blue semiconductor laser element 2.

[Structure of Blue Semiconductor Laser Element 2]

As shown in FIGS. 2A and 2B, the blue semiconductor laser element 2 has a sapphire substrate 5, a resonance ridge portion A, and a hole injection ridge portion B, and serves to emit a blue light having a wavelength of 442 nm as the excitation light a. A buffer layer 6 which has a thickness of about 50 nm and which is made of aluminum nitride (AlN) is formed on the sapphire substrate 5. At that, GaN, GaInN or AlGaN may also be used as the material for the buffer layer 6.

An n-type layer 7 which has a thickness of about 4.0 μm and which is made of a silicon (Si)-doped GaN having an electron concentration of 1×10¹⁸ cm⁻³, an n-type cladding layer 8 which has a thickness of about 500 nm and which is made of Si-doped Al_{0.1}Ga_{0.9}N having an electron concentration of 1×10¹⁸ cm⁻³, an n-type guide layer 9 which has a thickness of 100 nm and which is made of a Si-doped GaN having an electron concentration of 1×10¹⁸ cm⁻³, and an active layer 10 having a multi-quantum well (MQW) structure in which a barrier layer 62 which has a thickness of about 35 Å and which is made of GaN, and a well layer 61 which has a thickness of about 35 Å and which is made of Ga_{0.95}In_{0.05}N are alternately deposited are formed in this order on the buffer layer 6.

A p-type guide layer 11 which has a thickness of about 100 nm and which is made of magnesium (Mg)-doped GaN having a hole concentration of 5×10¹⁷ cm⁻³, a p-type layer 12 which has a thickness of about 50 nm and which is made of Mg-doped Al_{0.25}Ga_{0.75}N having a hole concentration of 5×10¹⁷ cm⁻³, a p-type cladding layer 13 which has a thickness of about 500 nm and which is made of Mg-doped Al_{0.1}Ga_{0.9}N having a hole concentration of 5×10¹⁷ cm⁻³, and a p-type contact layer 14 which has a thickness of about 200 nm and which is made of Mg-doped GaN having a hole concentration of 5×10¹⁷ cm⁻³ are formed in this order on the active layer 10. At that, AlGaN or GaInN may also be used as the material for the p-type contact layer 14.

An electrode 15 which has a width of 5 μm and which is made of nickel (Ni) is formed on the p-type contact layer 14. In addition, an electrode 16 made of aluminum (Al) is formed on the n-type layer 7.

The resonance ridge portion A includes the n-type cladding layer 8, the n-type guide layer 9, the active layer 10, the p-type guide layer 11, and the p-type layer 12. In addition, the hole injection ridge portion B includes the p-type cladding layer 13, the p-type contact layer 14, and the electrode 15.

[Construction of Laser Resonator 3]

The laser resonator 3 includes a fluorescent fiber 17 as a laser medium, and is optically connected to the blue semiconductor laser element 2 through the optical lens 4. As described above, the laser resonator 3 serves to amplify the excitation light (blue light) “a” emitted from the blue semiconductor laser element 2, and the wavelength conversion light obtained through the wavelength conversion by the excitation light in accordance with the induced emission.

As shown in FIG. 3, the fluorescent fiber 17 has a core 17A and a cladding member 17B. The fluorescent fiber 17 has one side end face (incidence face) to which the blue light from the blue semiconductor laser element 2 is made incident, and the other side end face (emission face) from which a part of the blue light is emitted as it is and for example, green, orange and red wavelength conversion lights which are obtained through the wavelength conversion of a part of the blue light within the core 17A are emitted, respectively. The fluorescent fiber 17 is made of a fluorescent glass which does not contain therein any of ZrF₄, HfF₄, ThF₄ and the like, but contains therein AlF₃ as a main constituent. Thus, the stable glass is obtained which is transparent for a light range from a visible range to an infrared range, and has the excellent chemical durability and the large mechanical strength. This sort of glass has such an advantage essential to the fluorescent glass that the phonon energy is less.

A fiber length of the fluorescent fiber 17 is set to such a size of about 20 mm that the fluorescent fiber 17 does not absorb all the excitation light “a” from the blue semiconductor laser element 2, but emits therefrom the green light, the orange light, and the red light in accordance with the laser oscillation. Dielectric mirrors 18 and 19 in each of which a silicon dioxide (SiO₂) layer and a titanium dioxide (TiO₂) layer are laminated and which serve as respective dichroic mirror portions constituting the laser resonator 3 are disposed in the fiber end faces of the fluorescent fiber 17, respectively. One dielectric mirror 18 functions as an input mirror, and the other dielectric mirror 19 functions as an output mirror.

The core 17A is formed of a wavelength-converting member including a low phonon glass such as an infrared radiation transmissive fluorescent glass containing therein at least praseodymium ions (Pr³⁺) as trivalent rare earth ions by about 500 ppm. Also, the core 17A serves to emit the green, orange and red wavelength conversion lights by being excited by a part of the excitation light (blue light) “a” from the blue semiconductor laser element 2. A core diameter of the core 17A is set to a size of about 6 μm. At that, in addition to the infrared radiation transmissive fluorescent glass, a heavy metal oxide glass is used as the low phonon glass.

The cladding member 17B is formed in the periphery of the core 17A, and the overall cladding member 17B is made of a glass or a transparent resin. A refractive index n1 of the cladding member 17B is set to smaller one (n1≈1.45) than that n2 (n2≈1.5) of the core 17A. A cladding diameter (an outer diameter of the fluorescent fiber 17) of the cladding member 17B is set to a size of about 200 μm. A peripheral surface of the cladding member 17B is covered with a cover member 18 made of a light-transmissive resin or a light-nontransmissive resin.

[Structure of Optical Lens 4]

The optical lens 4 is constituted by a double-convex lens, and is disposed between the blue semiconductor laser element 2 and the laser resonator 3 in the manner as described above. Also, the optical lens 4 serves to condense the excitation light a emitted from the blue semiconductor laser element 2 to a portion located in the incidence side end face of the dielectric mirror 18, i.e., the input side end face of the fluorescent fiber 17 (the core 17A).

[Operation of Light-Emitting Device 1]

Firstly, when a suitable voltage is applied from a power source to the blue semiconductor laser element 2, a luminous layer of the blue semiconductor laser element 2 emits the blue light “a”, and the blue light “a” is radiated to the optical lens 4 side. The blue light “a” emitted from the blue semiconductor laser element 2 is then made incident to the dielectric mirror 18 of the laser resonator 3 through the optical lens 4. In the laser resonator 3, the blue light a then penetrates the dielectric mirror 18 to be made incident to the core 17A of the fluorescent fiber 17, and is guided to the dielectric mirror 18 while total reflection thereof is made within the core 17A. Then, when reaching the dielectric mirror 18, the blue light “a” is reflected by the dielectric mirror 19 to be guided to the dielectric mirror 18 while the total reflection thereof is made within the core 17A. In this case, the blue light “a” is reflected between both the dielectric mirrors 18 and 19 within the core 17A, and excites the praseodymium ions, whereby the green, orange and red wavelength conversion lights are emitted, respectively. After that, the blue light “a”, and the green, orange and red wavelength conversion lights penetrate the dielectric mirror 19 to be emitted in the form of a multiple wavelength output light “b” to the outside of the laser resonator 3.

Next, a description will be given with respect to the results of an experiment of observing the multiple wavelength output light “b” emitted from the light-emitting device 1 according to this embodiment of the present invention.

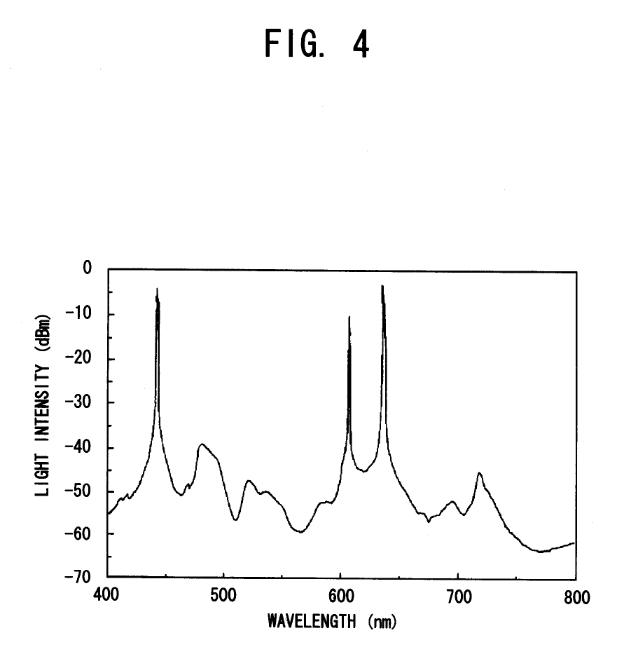

This experiment was made such that the dielectric mirror 18 which transmitted the blue light “a”, but reflected the orange and red lights by 99% was prepared as an input mirror, and the dielectric mirror 19 which reflects the orange light and the red light by 90% was prepared as an output mirror, and the blue light (its wavelength was 442 nm) from the blue semiconductor laser element 2 (under the excitation conditions of 20 mW and 35 mW) was made incident to the laser resonator 3. As a result of the experiment, the red light having a wavelength of 635 nm as the wavelength conversion light was confirmed together with the blue light having the wavelength of 442 nm as the excitation light “a” under the excitation condition of 20 mW, and the red light having a wavelength of 635 nm as the wavelength conversion light and the orange light having a wavelength of 606 nm as the wavelength conversion light were also confirmed together with the blue light having the wavelength of 442 nm as the excitation light “a” under the excitation condition of 35 mW. When the emitted light during the emission of the red and orange lights was measured, there was observed an emission spectrum having sharp emission wavelength peaks of the blue light as the excitation light, and the red and orange lights as the wavelength conversion lights. The observation results are shown in the form of a spectrum diagram in FIG. 4. In FIG. 4, an axis of ordinate represents the light intensity, and an axis of abscissa represents a wavelength.

According to the first embodiment as has been described so far, the following effects are obtained.

(1) Since the single laser light source (the blue semiconductor laser element 2) outputs the multiple wavelength laser light, the number of components or parts can be reduced, and thus the low cost promotion and miniaturization of the overall light-emitting device can be realized.

(2) Since the fluorescent fiber 17 is made of the low phonon glass including the fluoride glass which does not contain therein any of ZrF₄, HfF₄, ThF₄ and the like, but contains therein AlF₃ as the main constituent, the mechanical strength and chemical durability of the fluorescent fiber 17 are enhanced, and thus the fluorescent fiber 17 can be prevented from being damaged and deteriorated.

(3) Since the blue light having the wavelength of 442 nm is used as the excitation light “a”, the desired (pure) blue light can be obtained as the light emitted through the light emission face of the fluorescent fiber 17.

### Second Embodiment

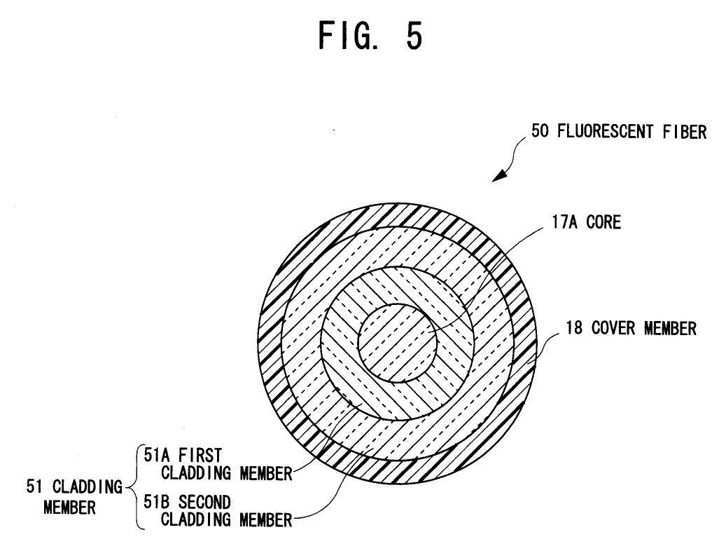

FIG. 5 is a cross sectional view for explaining a fluorescent fiber of a light-emitting device according to a second embodiment of the present invention. In FIG. 5, the same members as those shown in FIG. 3 are designated with the same reference numerals, and its detailed description is omitted here.

As shown in FIG. 5, the feature of the light-emitting device 1 (as shown in FIG. 1) in the second embodiment is that the light-emitting device 1 includes a fluorescent fiber 50 having a cladding member 51 including a first cladding member 51A which is formed adjacently to the peripheral surface of the core 17A, and a second cladding member 51B which is formed adjacently to a peripheral surface of the first cladding member 51A.

For this reason, a refractive index n1 of the first cladding member 51A is set to one (n1≈1.48) that is smaller than that n2 (n2≈1.50) of the core 17A, but is larger than that n3 (n3≈1.45) of the second cladding member 51B.

According to the second embodiment as has been described so far, in addition to the effects (1) to (3) of the first embodiment, the following effect is obtained.

The first cladding member 51A can function as an optical waveguide. Also, the green, orange and red wavelength conversion lights can be obtained by deriving the excitation light “a” guided to the first cladding member 51A into the core 17A.

While the light-emitting device of the present invention has been described in accordance with the above-mentioned first and second embodiments, it should be noted that the present invention is not intended to be limited to the above-mentioned first and second embodiments, and can be implemented in the form of various kinds of aspects without departing the gist thereof. For example, the following changes can be made.

(1) While in the first and second embodiments, the description has been given with respect to the case where the dichroic mirror portions constituting the laser resonator 3 are formed by disposing the dielectric mirrors 18 and 19 in the fiber end faces of the fluorescent fiber 17, respectively, the present invention is not limited thereto. That is to say, the dichroic mirror portions may also be formed by evaporating reflecting films onto the fiber end faces of the optical fiber, respectively. In addition, the dichroic mirror portions may also be formed by disposing reflecting mirrors in positions facing the fiber end faces of the fluorescent fiber through collimate lenses, respectively.

(2) While in the first and second embodiments, the description has been given with respect to the case where the blue light having the wavelength of 442 nm is used as the excitation light “a” emitted from the blue semiconductor laser element 2, the present invention is not limited thereto. That is to say, the blue light having the high excitation efficiency, and having a wavelength falling within the range of 440 to 460 nm in which that blue light can be used as the output light as it is may be used as the excitation light “a”.

(3) While in the first and second embodiments, the description has been given with respect to the case where a content m of the trivalent praseodymium ions (Pr³⁺) is set to 500 ppm, the present invention is not limited thereto. That is to say, the content m of the trivalent praseodymium ions may be set to one falling within the range of 100 ppm≦m≦10,000 ppm. In this case, when the content m is less than 100 ppm, neither of the wavelength conversion lights is obtained within the core 17A. On the other hand, when the content m is more than 10,000 ppm, the light-transmissive property within the core 17A becomes poor.

What is claimed is:

1. A multiple wavelength laser light source using a fluorescent fiber, comprising:
a blue semiconductor laser element for emitting an excitation light; and
an optical fiber having a first side fiber end face and a second side fiber face, the excitation light emitted from the blue semiconductor laser element being made incident to the first side fiber end face, the excitation light thus made incident to the first side fiber end face being emitted through the second side fiber face,
wherein the optical fiber has dichroic mirror portions constituting a laser resonator in its first and second side fiber end faces, respectively, and a core of the optical fiber is made of a wavelength-converting member including a low phonon glass containing therein at least praseodymium ions as trivalent rare earth ions for emitting wavelength conversion lights by being excited by the excitation light.

2. A multiple wavelength laser light source using a fluorescent fiber according to claim 1, wherein:
a content m of the trivalent praseodymium ions is set to a range of 100 ppm≦m≦10,000 ppm.

3. A multiple wavelength laser light source using a fluorescent fiber according to claim 1, wherein:
a cladding member of the optical fiber includes a first cladding member formed adjacently to a peripheral surface of the core, and a second cladding member formed adjacently to a peripheral surface of the first cladding member, and a refractive index of the first cladding member is set to one that is smaller than that of the core, but is larger than that of the second cladding member.

4. A multiple wavelength laser light source using a fluorescent fiber according to claim 1, wherein:
the dichroic mirror portions are formed by disposing reflecting mirrors in the first and second side fiber end faces of the optical fiber, respectively.

5. A multiple wavelength laser light source using a fluorescent fiber according to claim 1, wherein:
the dichroic mirror portions are formed by evaporating reflecting films onto the first and second side fiber end faces of the optical fiber, respectively.

6. A multiple wavelength laser light source using a fluorescent fiber, comprising:
a blue semiconductor laser element for emitting an excitation light; and
an optical fiber having a first side fiber end face and a second side fiber end face, the excitation light emitted from the blue semiconductor laser element being made incident to the first side fiber end face, the excitation light thus made incident to the first side fiber end face being emitted through the second side fiber end face,
wherein the optical fiber has dichroic mirrors constituting a laser resonator in its first and second side fiber end faces, respectively, and a core of the optical fiber is made of a wavelength-converting member including a low phonon glass containing therein a phosphor for emitting wavelength conversion lights by being excited by an excitation light having a wavelength of 440 to 460 nm as the excitation light.

7. A multiple wavelength laser light source using a fluorescent fiber according to claim 6, wherein:
a cladding member of the optical fiber includes a first cladding member formed adjacently to a peripheral surface of the core, and a second cladding member formed adjacently to a peripheral surface of the first cladding member, and a refractive index of the first cladding member is set to one that is smaller than that of the core, but is larger than that of the second cladding member.

8. A multiple wavelength laser light source using a fluorescent fiber according to claim 6, wherein:
the dichroic mirror portions are formed by disposing reflecting mirrors in the first and second side fiber end faces of the optical fiber, respectively.

9. A multiple wavelength laser light source using a fluorescent fiber according to claim 6, wherein:
the dichroic mirror portions are formed by evaporating reflecting films onto the first and second side fiber end faces of the optical fiber, respectively.

10. A multiple wavelength laser light source using a fluorescent fiber, comprising:
a blue semiconductor laser element for emitting a laser light;
an optical fiber having a core for a wavelength-converting member containing a low phonon glass and at least praseodymium ions as trivalent rare earth ions, a first fiber end face to which the laser light is supplied, and a second fiber end face which is a light source for a multiple wavelength laser light; and
first and second dichroic mirror portions, respectively, provided on the first and second fiber end faces of the optical fiber to provide a laser resonator for emitting the multiple wavelength laser light from the second fiber end face of the optical fiber.

11. A multiple wavelength laser light source using a fluorescent fiber according to claim 10, wherein:
a content of the praseodymium ions ranges 100 ppm to 10,000 ppm.

12. A multiple wavelength laser light source using a fluorescent fiber according to claim 10, wherein:
the blue semiconductor laser element emits the laser light of a wavelength ranging 440 nm to 460 nm.

13. A multiple wavelength laser light source using a fluorescent fiber according to claim 10, wherein:
the optical fiber comprises a first cladding member provided on an outer periphery of the core, and a second cladding member provided on an outer periphery of the first cladding member, the first cladding member having a refractive index smaller than that of the core and larger than that of the second cladding member.

14. A multiple wavelength laser light source using a fluorescent fiber according to claim 10, wherein:
the first and second dichroic mirror portions are provided by placing first and second reflecting mirrors, respectively, on the first and second fiber end faces of the optical fiber.

15. A multiple wavelength laser light source using a fluorescent fiber according to claim 10, wherein:
the first and second dichroic mirror portions are provided by evaporating first and second reflecting films, respectively, on the first and second fiber end faces of the optical fiber.
